(19) United States
(12) Patent Application Publication
(10) Pub. No.: US 2026/0361431 A1
(43) Pub. Date: Nov. 12, 2026

(54) IDENTIFICATION FOR SMALL DATA TRANSMISSION

(71) Applicant: Nokia Technologies Oy, Espoo (FI)

(72) Inventors: Samuli Heikki TURTINEN, Ii (FI); Jussi-Pekka KOSKINEN, Oulu (FI); Chunli WU, Beijing (CN)

(21) Appl. No.: 19/125,675

(22) PCT Filed: Nov. 2, 2022
(86) PCT No.: PCT/CN2022/129346

§ 371 Date: Apr. 29, 2025

(51) Int. Cl. H04B 17/318; H04L 5/00

(52) U.S. Cl. CPC H04B 17/328; H04L 5/0044

(57) ABSTRACT

Embodiments of the present disclosure relate to identification for small data transmission (SDT). A terminal device receives, from a network device, a message comprising at least a first identifier of the terminal device for a non-small data transmission (non-SDT) procedure and a second identifier of the terminal device for an SDT procedure. Moreover, the terminal device transmits, to the network device, a request message comprising the first identifier or the second identifier. As a result, it is possible to avoid additional signalling overhead, save power consumption and improve transmission efficiency.

### FIELD

Various example embodiments relate to the field of telecommunication and in particular, to methods, devices, apparatuses, and computer readable storage media for identification for small data transmission (SDT).

### BACKGROUND

In New Radio (NR), to avoid signaling overhead and delay associated with state transition of user equipment (UE) from a radio resource control INACTIVE (RRC_INACTIVE) state to an RRC_CONNECTED state, a transmission scheme called SDT has been proposed to facilitate data transmission. In the SDT, data interaction between a base station and a UE may be achieved, while the UE is in the RRC_INACTIVE state during the transmission. However, there are still some open problems in SDT that will be studied in the near future.

### SUMMARY

In general, example embodiments of the present disclosure provide a solution related to identification for SDT.

In a first aspect, there is provided a terminal device. The terminal device comprises at least one processor and at least one memory storing instructions that, when executed by the at least one processor, cause the terminal device at least to: receive, from a network device, a message comprising at least a first identifier of the terminal device for a non-small data transmission (non-SDT) procedure and a second identifier of the terminal device for an SDT procedure; and transmit, to the network device, a request message comprising the first identifier or the second identifier.

In a second aspect, there is provided a network device. The network device comprises at least one processor and at least one memory storing instructions that, when executed by the at least one processor, cause the network device at least to: transmit, to a terminal device, a message comprising at least a first identifier of the terminal device for a non-small data transmission (non-SDT) procedure and a second identifier of the terminal device for an SDT procedure; and receive, from the terminal device, a request message comprising the first identifier or the second identifier.

In a third aspect, there is provided a method implemented at a terminal device. The method comprises receiving, from a network device, a message comprising at least a first identifier of the terminal device for a non-small data transmission (non-SDT) procedure and a second identifier of the terminal device for an SDT procedure; and transmitting, to the network device, a request message comprising the first identifier or the second identifier.

In a fourth aspect, there is provided a method implemented at a network device. The method comprises transmitting, to a terminal device, a message comprising at least a first identifier of the terminal device for a non-small data transmission (non-SDT) procedure and a second identifier of the terminal device for an SDT procedure; and receiving, from the terminal device, a request message comprising the first identifier or the second identifier.

In a fifth aspect, there is provided an apparatus. The apparatus comprises means for receiving, at a terminal device from a network device, a message comprising at least a first identifier of the terminal device for a non-small data transmission (non-SDT) procedure and a second identifier of the terminal device for an SDT procedure; and means for transmitting, to the network device, a request message comprising the first identifier or the second identifier.

In a sixth aspect, there is provided an apparatus. The apparatus comprises means for transmitting, at a network device to a terminal device, a message comprising at least a first identifier of the terminal device for a non-small data transmission (non-SDT) procedure and a second identifier of the terminal device for an SDT procedure; and means for receiving, from the terminal device, a request message comprising the first identifier or the second identifier.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to perform at least the method according to any one of the above third to fourth aspect.

In a ninth aspect, there is provided a terminal device. The terminal device comprises receiving circuitry configured to receive, from a network device, a message comprising at least a first identifier of the terminal device for a non-small data transmission (non-SDT) procedure and a second identifier of the terminal device for an SDT procedure; and transmitting configured to transmitting, to the network device, a request message comprising the first identifier or the second identifier.

In a tenth aspect, there is provided a network device. The network device comprises transmitting circuitry configured to transmit, to a terminal device, a message comprising at least a first identifier of the terminal device for a non-small data transmission (non-SDT) procedure and a second identifier of the terminal device for an SDT procedure; and receiving circuitry configured to receive, from the terminal device, a request message comprising the first identifier or the second identifier.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the terminal device and the network device according to some example embodiments of the present disclosure;

FIG. 3 illustrates an example communication process between the terminal device and the network device according to some example embodiments of the present disclosure;

FIG. 4 illustrates a flowchart of a method implemented at a terminal device according to some embodiments of the present disclosure;

FIG. 5 illustrates a flowchart of a method implemented at a network device according to some embodiments of the present disclosure;

FIG. 6 illustrates a simplified block diagram of a device that is suitable for implementing some example embodiments of the present disclosure; and

FIG. 7 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a New Radio (NR) NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

For mobile originated (MO) SDT, the UE may indicate the initiation of the SDT procedure by dedicated RACH resources that NW may have configured. If such RACH resources do not exist (that is, SDT also uses common RACH resources that are not reserved or configured for the SDT), the network device may only deduce the need for SDT from a buffer state report (BSR) which is indicated by the UE in message 3 (Msg3) of the random access procedure if there is enough space after including the common control channel (CCCH) service data unit (SDU)/RRCResumeRequest) or then after the successful contention resolution of the random access procedure. This solution, on the other hand, affects similarly legacy UEs/other UEs not performing SDT since these UEs would also need to report the BSR with zero UL buffer and consume power for unnecessary uplink transmission(s).

Furthermore, for MO-SDT, the UE evaluates whether it may trigger an SDT procedure based on a data amount threshold and, if configured, reference signal received power (RSRP) of the communication link, as specified in the following third-generation partnership project (3GPP) technical specification (TS) 38.321 v17.2.0:

5.27 Small Data Transmission
5.27.1 General
The MAC entity shall, if initiated by the upper layers for SDT procedure:

| | |
|---|---|
| 1> | if the data volume of the pending UL data across all RBs configured for SDT is less than or equal |
| | to sdt-DataVolumeThreshold; and |

| NOTE: | For SDT procedure, the MAC entity also considers the suspended RBs configured with |
|---|---|
| | SDT for data volume calculation. It is up to the UE's implementation how the UE |
| | calculates the data volume for the suspended RBs. Size of the CCCH message is not |
| | considered for data volume calculation |

| | |
|---|---|
| 1> | if the RSRP of the downlink pathloss reference is higher than sdt-RSRP-Threshold; or |
| 1> | if sdt-RSRP-Threshold is not configured: |

Moreover, a new work item for mobile terminated (MT) SDT for NR has been discussed. The following recaps the justification and the objectives of the work:

3 Justification
Rel-17 specified MO-SDT to allow small packet transmission for UL-oriented packets. For DL, MT-SDT
(i.e. DL-triggered small data) allows similar benefits, i.e. 1) reducing signalling overhead and UE power
consumption by not transitioning to RRC_CONNECTED and reducing latency by allowing fast
transmission of (small and infrequent) packets, e.g. for positioning.
4 Objective
4.1 Objective of SI or Core part WI or Testing part WI
Specify the support for paging-triggered SDT (MT-SDT) [RAN2, RAN3]

| | |
|---|---|
| • | MT-SDT triggering mechanism for UEs in RRC_INACTIVE, supporting RA-SDT and CG-SDT |
| | as the UL response; |
| • | MT-SDT procedure for initial DL data reception and subsequent UL/DL data transmissions in |
| | RRC_INACTIVE. |

Note: Data transmission in DL within paging message is not in scope of this WI.

A UE in RRC_INACTIVE is paged with an I-RNTI. To enable the UE to indicate the initiation of a resume procedure is for a regular resume procedure or as a response to the MT-SDT paging, one solution could be to use a new resumeCause to indicate the initiation is for the MT-SDT or any other reason, such as long term evolution (LTE) MT early data transmission (EDT).

However, this solution causes an additional paging overhead problem. Although there could be only 1 bit cause value overhead added into the paging message per each UE MT-SDT paging is transmitted, there is a need to do nonCriticalExtension from the previous release(s), which may not be preferred in 3GPP since such resumeCause was neither introduced for MO-SDT use cases.

| Paging ::= | SEQUENCE { | |
|---|---|---|
| pagingRecordList | PagingRecordList | OPTIONAL, -- |

Need ON

| | | |
|---|---|---|
| systemInfoModification | ENUMERATED {true} | OPTIONAL, |

-- Need ON

| | |
|---|---|
| etws-Indication | ENUMERATED {true} |

OPTIONAL, -- Need ON

| | | |
|---|---|---|
| nonCriticalExtension | Paging-v890-IEs | OPTIONAL |

}

| Paging-v890-IEs ::= | SEQUENCE { | |
|---|---|---|
| lateNonCriticalExtension | OCTET STRING | OPTIONAL, |
| nonCriticalExtension | Paging-v920-IEs | OPTIONAL |

}

| Paging-v920-IEs ::= | SEQUENCE { | |
|---|---|---|
| cmas-Indication-r9 | ENUMERATED {true} | OPTIONAL, |

-- Need ON

| | | |
|---|---|---|
| nonCriticalExtension | Paging-v1130-IEs | OPTIONAL |

}

| Paging-v1130-IEs ::= | SEQUENCE { | |
|---|---|---|
| eab-ParamModification-r11 | ENUMERATED {true} | OPTIONAL, |

-- Need ON

| | | |
|---|---|---|
| nonCriticalExtension | Paging-v1310-IEs | OPTIONAL |

}

| Paging-v1310-IEs ::= | SEQUENCE { | |
|---|---|---|
| redistributionIndication-r13 | ENUMERATED {true} | OPTIONAL, -- |

Need ON

| | |
|---|---|
| systemInfoModification-eDRX-r13 | ENUMERATED {true} |

OPTIONAL, -- Need ON

| | | |
|---|---|---|
| nonCriticalExtension | Paging-v1530-IEs | OPTIONAL |

}

| | |
|---|---|
| Paging-v1530-IEs ::= | SEQUENCE { |
| accessType | ENUMERATED {non3GPP} |

OPTIONAL, -- Need ON

| | | |
|---|---|---|
| nonCriticalExtension | Paging-v1610-IEs | OPTIONAL |

}

| Paging-v1610-IEs ::= | SEQUENCE { | |
|---|---|---|
| pagingRecordList-v1610 | PagingRecordList-v1610 | OPTIONAL, |

-- Need ON

| | | |
|---|---|---|
| uac-ParamModification-r16 | ENUMERATED {true} | OPTIONAL, |

-- Need ON

| | | |
|---|---|---|
| nonCriticalExtension | Paging-v1700-IEs | OPTIONAL |

}

| Paging-v1700-IEs ::= | SEQUENCE { | |
|---|---|---|
| pagingRecordList-v1700 | PagingRecordList-v1700 | OPTIONAL, -- |

Need ON

| | |
|---|---|
| nonCriticalExtension | SEQUENCE { } |

OPTIONAL
}

| | |
|---|---|
| PagingRecordList ::= | SEQUENCE (SIZE (1..maxPageRec)) OF PagingRecord |
| PagingRecordList-v1610 ::= | SEQUENCE (SIZE (1..maxPageRec)) OF |

PagingRecord-v1610

| | |
|---|---|
| PagingRecordList-v1700 ::= | SEQUENCE (SIZE (1..maxPageRec)) OF |

PagingRecord-v1700

| | |
|---|---|
| PagingRecord ::= | SEQUENCE { |
| ue-Identity | PagingUE-Identity, |
| cn-Domain | ENUMERATED {ps, cs}, |

...
}

| | |
|---|---|
| PagingRecord-v1610 ::= | SEQUENCE { |
| accessType-r16 | ENUMERATED {non3GPP} |

OPTIONAL, -- Need ON

| | |
|---|---|
| mt-EDT-r16 | ENUMERATED {true} |

OPTIONAL -- Need ON
}

| | |
|---|---|
| PagingRecord-v1700 ::= | SEQUENCE { |
| pagingCause-r17 | ENUMERATED {voice} |

OPTIONAL -- Need ON
}

| | |
|---|---|
| PagingUE-Identity ::= | CHOICE { |
| s-TMSI | S-TMSI, |
| imsi | IMSI, |

...,

| | |
|---|---|
| ng-5G-S-TMSI-r15 | NG-5G-S-TMSI-r15, |
| fullI-RNTI-r15 | I-RNTI-r15 |

}

| | |
|---|---|
| IMSI ::= | SEQUENCE (SIZE (6..21)) OF IMSI-Digit |
| IMSI-Digit ::= | INTEGER (0..9) |

-- ASN1STOP

However, any additional information included in the paging record will increase the overhead of the paging procedure within the whole UE RAN Notification Area (RNA) within each beam of the cell.

Therefore, by now, there is no effective way to provide paging for the MT-SDT for the UE and enable the UE to indicate the initiation of a resume procedure is for a regular resume procedure (that is, a non-SDT resume procedure) or an SDT resume procedure.

According to embodiments of the present disclosure, there is provided a scheme for identification for MT-SDT paging purpose and SDT initiation. With this scheme, a terminal device receives, from a network device, a message comprising at least a first identifier of the terminal device for a non-small data transmission (non-SDT) procedure and a second identifier of the terminal device for an SDT procedure. Moreover, the terminal device transmits, to the network device, a request message comprising the first identifier or the second identifier.

This scheme optimizes the identification for SDT by comprising different identifiers in the request message to the network device. In this way, it is possible to avoid additional signalling overhead, save power consumption and improve transmission efficiency.

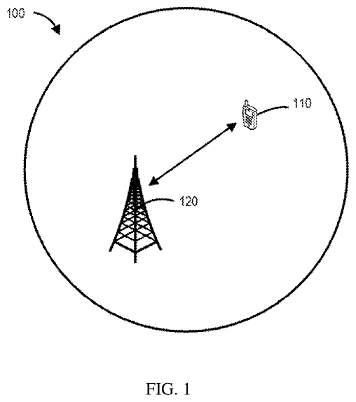

Principle and embodiments of the present disclosure will be described in detail below with reference to the accompanying drawings. Reference is first made to FIG. 1, which illustrates an example environment 100 in which example embodiments of the present disclosure can be implemented.

The environment 100, which may be a part of a communication network, comprises a terminal device 110 and a network device 120 communicating with each other or with other devices via each other.

The communication environment 100 may comprise any suitable number of devices and cells. In the communication environment 100, the terminal device 110 and the network device 120 can communicate data and control information with each other. A link from the network device 120 to the terminal device 110 is referred to as a downlink (DL), while a link from the terminal device 110 to the network device 120 is referred to as an uplink (UL).

It is to be understood that two devices are shown in the environment 100 only for the purpose of illustration, without suggesting any limitation to the scope of the present disclosure. In some example embodiments, the environment 100 may comprise a further device to communicate with the terminal device 110 and network device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connectivity (DC), and New Radio Unlicensed (NR-U) technologies.

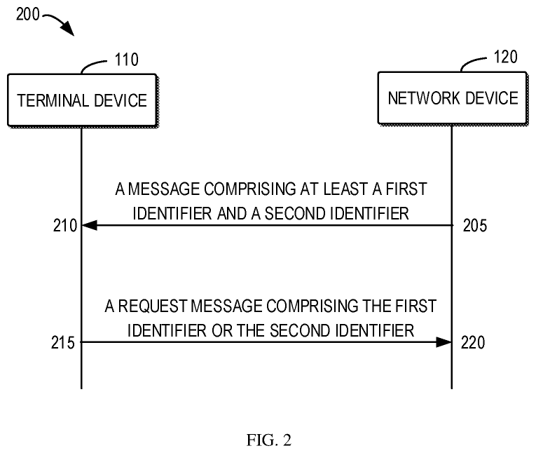

FIG. 2 illustrates a signaling flow 200 between the terminal device and the network device according to some example embodiments of the present disclosure. For the purpose of discussion, the signaling flow 200 will be described with reference to FIG. 1.

As shown in FIG. 2, the network device 120 transmits (205), to the terminal device 110, a message comprising at least a first identifier of the terminal device 110 for a non-SDT procedure and a second identifier of the terminal device for an SDT procedure. Accordingly, the terminal device 110 receives (210) from the network device 120 the message. For example, the message may be a release message, such as an RRC release message to indicate the terminal device 110 to enter the RRC_INACTIVE state or RRC_IDLE state. As an example, the non-SDT procedure may be a non-SDT resume procedure, also referred to as a regular resume procedure, and the SDT procedure may be an SDT resume procedure. A non-SDT resume procedure may comprise a regular RRC resume procedure where UE is moved RRC_INACTIVE state to RRC_CONNECTED state. As another example, the message may be a reconfiguration message, such as an RRC reconfiguration message.

In some example embodiments, the first and second identifiers may be inactive radio network temporary identifiers (I-RNTIs). For example, the first and second identifiers may be full I-RNTIs. As another example, the first and second identifiers may be short I-RNTIs. As another example, the first and second identifiers may be S-Temporary Mobile Subscriber Identity (S-TMSI). In some example embodiments, if only the first identifier is configured to be a short I-RNTI and the second identifier is not configured, the terminal device 110 may only initiate regular SDT procedure.

The terminal device 110 transmits (215), to the network device 120, a request message comprising the first identifier or the second identifier. Accordingly, the network device receives (220) from the terminal device 110 the request message. For example, the request message may be a resume request message. In this case, as an example, the resume request message may be used to initiate an MT-SDT resume procedure, an MO-SDT resume procedure or a regular resume procedure. For another example, the request message may be a setup request message.

In some example embodiments, prior to receiving the request message, the network device 120 may transmit to the terminal device 110 a paging message. The paging message may comprise the first or the second identifier.

In some example embodiments, if the paging message comprises the first identifier, the terminal device 110 may, as a response to the paging message, transmit to the network device 120 the request message comprising the first identifier. In this case, prior to transmitting the request message comprising the first identifier, the terminal device 110 may initiate the non-SDT resume procedure. For example, at least one RACH resource that is not configured for SDT (also referred to as a common RACH resource) may be used for the initiation of the non-SDT resume procedure.

In some other example embodiments, if the paging message comprises the second identifier, the terminal device 110 may, as a response to the paging message, transmit to the network device 120 the request message comprising the second identifier. In this case, prior to transmitting the request message comprising the second identifier, the terminal device 110 may initiate the SDT resume procedure. Upon the initiation of the SDT resume procedure, the terminal device 110 may resume the data radio bearers (DRBs)/signaling radio bearers (SRBs) configured for SDT. For example, at least one RACH resource that is not configured for SDT may be used for the initiation of the SDT procedure, so that the MO-SDT in the cell does not need to be a prerequisite for enabling the MT-SDT. Accordingly, on the network side, the network device 120 may determine that the SDT resume procedure is initiated on at least one RACH resource that is not configured for SDT based on the second identifier in the request message.

In this case, as the terminal device 110 may or may not have any uplink SDT data to be transmitted, it would not be necessary to use at least one RACH resource configured for SDT (if configured) in case the terminal device 110 does not have any uplink SDT data to transmit, since the network would likely allocate a bigger amount of resources for Msg3 transmission to fit at least part of the uplink SDT data into it. It would seem beneficial to allow the terminal device 110 to use normal RACH resources that are not configured for SDT to initiate the SDT procedure with MT-SDT access, so that the network device 120 may use Msg3 resources in case no uplink SDT data is available.

As an example, the second identifier may be an MT-SDT specific identifier (for example, an I-RNTI). In this case, the network device 120 may indicate the terminal device 110 to initiate MT-SDT using the MT-SDT specific identifier in the paging message or paging record. For example, the terminal device 110 may initiate the MT-SDT resume procedure if the MT-SDT specific identifier is received in the paging message, and initiate the regular non-SDT resume procedure if the regular identifier is received. Hence, this does not expose any additional overhead to be introduced to the paging message for the MT-SDT purpose, thus the legacy paging message may be reused.

In some example embodiments, the initiation of the SDT/non-SDT procedure may be further based on other condition checking at the terminal device side. For example, the condition checking may comprise RSRP checking, UL data checking, and the like. RSRP checking may be used to ensure successful transmission of the downlink data in case the terminal device 110 is in worse channel conditions than an RSRP threshold allows, for example, by using the non-SDT procedure in such a case.

As an example, after receiving the paging message, the terminal device 110 may further determine whether there is any uplink data in a buffer and/or whether the RSRP of communication link is above an RSRP threshold. For example, the RSRP threshold may be configured by the network device 120 or be pre-defined. As an example, the RSRP threshold may be different for MT-SDT than for MO-SDT. As an example, network device 120 may configure different RSRP thresholds for MT-SDT than for MO-SDT.

In some example embodiments, after receiving the paging message comprising the second identifier, if the terminal device 110 determines that there is no uplink SDT data in a buffer or the RSRP of communication link is below the RSRP threshold, it may initiate the non-SDT procedure on at least one RACH resource that is not configured for SDT. As another example, if the terminal device 110 determines that there is uplink non-SDT data in a buffer, it may also initiate the non-SDT procedure on at least one RACH resource that is not configured for SDT. The request message transmitted to the network device 120 may comprise the first identifier to indicate that a non-SDT procedure is required. Then, accordingly, on the network side, after transmitting the paging message comprising the second identifier, based on determining that the non-SDT procedure is initiated on at least one RACH resource that is not configured for SDT and the received request message comprises the first identifier, the network device 120 may determine that RSRP of communication link at the terminal device 110 is below an RSRP threshold or there is uplink non-SDT data at the terminal device 110 to be transmitted. Then, the network device 120 may configure the terminal device 110 to enter a connected state. For example, the network device 120 may transmit a resume message to the terminal device 110.

For example, in this case, the terminal device may further set a cause in the request message to indicate the cause of initiating the non-SDT procedure.

After receiving the paging message comprising the second identifier, if the terminal device 110 determines that there is no uplink data in a buffer and the RSRP of communication link is below an RSRP threshold, it may set the cause in the request message to a first cause value (for example, mt-Access resumeCause) indicating that the non-SDT procedure is for MT access or MT data. For example, the terminal device 110 may resume SDT bearers before transmitting the request message comprising the first identifier with the first cause value. As an example, in this case, the network device 120 may transmit, to the terminal device 110, SDT data without configuring the terminal device 110 to enter a connected state. In other words, in this case, the network device 120 may attempt to transmit the DL SDT data without bringing the terminal device 110 to the RRC_CONNECTED state even though it knows the measured RSRP at the terminal device 110 is below the RSRP threshold.

Otherwise, after receiving the paging message comprising the second identifier, if the terminal device 110 determines that there is uplink non-SDT data in a buffer, it may set the cause in the request message to a second cause value (for example, mo-data resumeCause) indicating that the non-SDT procedure is for MO access or MO data. Accordingly, based on the request message with the second cause value, the network device 120 may determine that there is uplink non-SDT data at the terminal device 110 to be transmitted.

In some example embodiments, after receiving the paging message comprising the second identifier, if the terminal device 110 determines that there is no uplink SDT data in a buffer, it may initiate the SDT procedure on the at least one RACH resource that is not configured for SDT, and then transmit the request message comprising the second identifier to the network device 120. As an example, the terminal device 120 may initiate the SDT procedure further based on the RSRP of communication link. For example, the terminal device 110 may initiate the SDT procedure, if it determines that the RSRP of communication link is above an RSRP threshold. Alternatively or in addition, the terminal device 110 may initiate the SDT procedure, if it determines that there is no uplink SDT data in a buffer and the RSRP of communication link is below an RSRP threshold. On the network side, based on determining that the SDT procedure is initiated on at least one RACH resource that is not configured for SDT and the received request message comprises the second identifier, the network device 120 may determine that there is no uplink SDT data at the terminal device 110 to be transmitted and then transmit, to the terminal device 110, SDT data without configuring the terminal device 110 to a connected state.

In some example embodiments, after receiving the paging message comprising the second identifier, if the terminal device 110 determines that there is uplink SDT data in a buffer, it may initiate the SDT procedure on at least one RACH resource configured for SDT, and then transmit the request message comprising the second identifier to the network device 120. As an example, the terminal device 120 may initiate the SDT procedure further based on the RSRP of communication link. For example, the terminal device 110 may initiate the SDT procedure, if it determines that there is uplink SDT data in a buffer and the RSRP of communication link is above an RSRP threshold. Alternatively or in addition, the terminal device 110 may initiate the SDT procedure, if it determines that there is uplink SDT data in a buffer and the RSRP of communication link is below an RSRP threshold. On the network side, based on determining that the SDT procedure is initiated on at least one RACH resource configured for SDT and the received request message comprises the second identifier, the network device 120 may determine that there is uplink SDT data at the terminal device 110 to be transmitted and the terminal device 110 has received the paging message comprising the second identifier.

In some example embodiments, if the terminal device 120 determines that there is uplink SDT data in a buffer and the RSRP of communication link is above an RSRP threshold, it may initiate the SDT procedure on at least one RACH resource configured for SDT, and then transmit, to the network device 120, the request message comprising the first identifier. In this case, for example, if the network device 120 has transmitted to the terminal device 110 the paging message comprising the second identifier, it may determine that the terminal device 120 has not received the paging message.

In some example embodiments, after receiving the paging message comprising the first identifier, the terminal device 110 may initiate the non-SDT procedure on at least one RACH resource that is not configured for SDT, and then transmit, to the network device 120, the request message comprising the first identifier. For example, there may be no UL-SDT data in the buffer. In this case, the second specific identifier may not be used although it is allocated. As another example, there may be UL-SDT data in the buffer. In this case, the second identifier may not be used although it is allocated, because the network device 120 has paged the terminal device 110 to use the non-SDT procedure. Accordingly, on the network side, the network device 120 may determine that the non-SDT procedure is initiated on at least one RACH resource that is not configured for SDT. The following non-SDT procedure may be continued.

In some example embodiments, the above identifiers can apply to MO-SDT cases. In this case, the second identifier may be used by the terminal device 110 for MO-SDT over at least one RACH resource that is not configured for SDT. For example, the network device 120 may indicate MO-SDT configuration in the cell but may not provide any SDT specific RACH resources. Then, if a condition to initiate MO-SDT is fulfilled (e.g. the RSRP threshold is met as explained in the next paragraph), the terminal device 110 may initiate an SDT procedure on at least one RACH resource that is not configured for SDT and use the second identifier in the request message to indicate that the initiation is for MO-SDT.

In this case, for example, prior to transmitting the request message, if the terminal device determines that there is uplink SDT data in a buffer and may further determine that the RSRP of communication link is above an RSRP threshold, it may initiate the SDT procedure on at least one RACH resource that is not configured for SDT, and then transmit, to the network device 120, the request message comprising the second identifier. In other words, the SDT procedure is a MO-SDT procedure. Accordingly, the network device 120 may determine that the SDT procedure is initiated on at least one RACH resource that is not configured for SDT, and then determine that the SDT procedure is a MO-SDT procedure based on the second identifier.

In this way, the simple and efficient mechanism can be used to provide paging for SDT and identification for initiating an SDT procedure or a regular non-SDT procedure based on the different identifiers. No additional overhead is exposed to any downlink or uplink RRC messages to initiate the SDT procedure (for example, the MT-SDT specific resume procedure) compared to regular RRC procedure (for example, regular RRC resume procedure). Besides, some cause values (for example, current resumeCause values) can be used to indicate other information useful to the network device 120 depending on different conditions at the terminal device side.

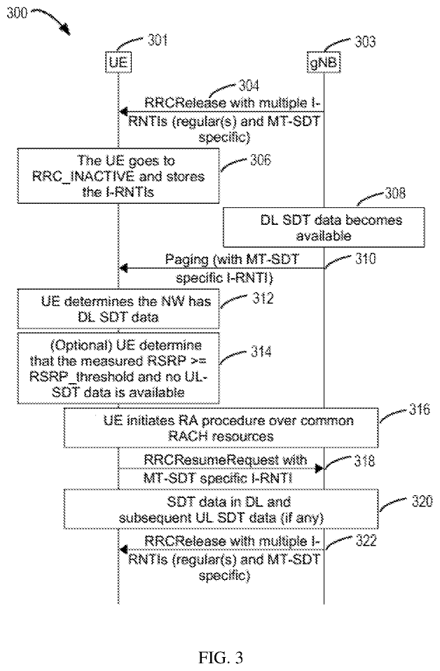

FIG. 3 illustrates an example communication process 300 between the terminal device and the network device according to some example embodiments of the present disclosure. For the purpose of discussion, the process 300 will be described with reference to FIG. 1. It would be appreciated that although the process 300 has been described in the network environment 100 of FIG. 1, this process flow may be likewise applied to other communication scenarios. In this case, the terminal device 110 is implemented by a UE 301, and the network device 120 is implemented by a gNB 303.

As shown in FIG. 3, at 304, the gNB 303 transmits to the UE 301 an RRCRelease message with multiple identifiers including at least a first identifier and a second identifier. For example, the identifiers are I-RNTIs. In this case, the first identifier is also referred as a regular I-RNTI, and the second identifier is also referred to as MT-SDT specific I-RNTI.

At 306, the UE 301 goes to an RRC_INACTIVE state and stores the above I-RNTIs. At 308, downlink SDT data becomes available. Then, at 310, the gNB 303 transmits to the UE 301 a paging message with MT-SDT specific I-RNTI.

At 312, the UE 301 determines that the gNB 303 has downlink SDT data to be transmitted. At 314, optionally, the UE 301 may further determine that the measured RSRP>=an RSRP threshold and no uplink SDT data is available.

Then, at 316, the UE 301 initiates a random access (RA) procedure over common RACH resources that are not configured for SDT. At 318, the UE 301 transmits to the gNB 303 an RRCResumeRequest message with MT-SDT specific I-RNTI.

At 320, SDT data in downlink is transmitted and subsequent uplink SDT data may be transmitted (if any). At 322, similar to step 304, the gNB 303 may transmit an RRCRelease message with multiple I-RNTIs comprising regular and MT-SDT specific I-RNTIs.

All operations and features as described above with reference to FIG. 2 are likewise applicable to the process 300 and have similar effects. For the purpose of simplification, the details will be omitted.

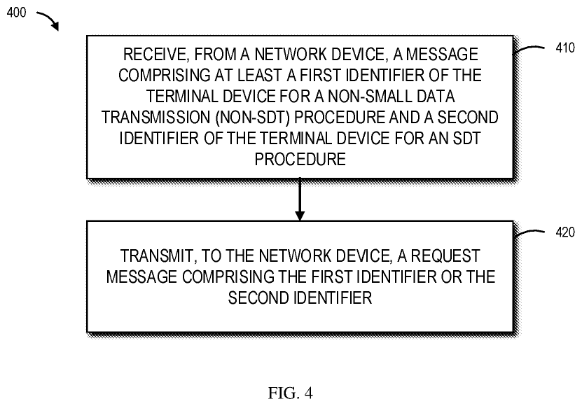

FIG. 4 illustrates a flowchart 400 of a method implemented at a terminal device 110 according to some embodiments of the present disclosure. For the purpose of discussion, the method 400 will be described from the perspective of the terminal device 110 with reference to FIG. 1.

At block 410, the terminal device 110 receives, from the network device 120, a message comprising at least a first identifier of the terminal device 110 for a non-small data transmission (non-SDT) procedure and a second identifier of the terminal device 110 for an SDT procedure. At block 420, the terminal device 110 transmits, to the network device 120, a request message comprising the first identifier or the second identifier.

In some example embodiments, the terminal device 110 transmits the request message by: based on receiving, from the network device 120, a paging message comprising the second identifier, transmitting, to the network device 120, the request message comprising the second identifier. In some example embodiments, the terminal device 110 further, prior to transmitting the request message comprising the second identifier, initiates the SDT procedure on at least one random access channel, RACH, resource that is not configured for SDT. In some example embodiments, the terminal device 110 initiates the SDT procedure by: based on determining that there is no uplink SDT data in a buffer, initiating the SDT procedure on the at least one RACH resource that is not configured for SDT. In some example embodiments, the terminal device 110 further, prior to transmitting the request message comprising the second identifier, based on determining that there is uplink SDT data in a buffer, initiates the SDT procedure on at least one RACH resource configured for SDT. In some example embodiments, the terminal device 110 initiates the SDT procedure by: further based on reference signal received power (RSRP) of communication link is above an RSRP threshold, initiating the SDT procedure. In some example embodiments, the terminal device 110 initiates the SDT procedure by: further based on RSRP of communication link is below an RSRP threshold, initiating the SDT procedure.

In some example embodiments, the terminal device 110 further receives, from the network device 120, a paging message comprising the second identifier; and prior to transmitting the request message, based on determining that there is no uplink SDT data in a buffer and RSRP of communication link is below an RSRP threshold or there is uplink non-SDT data in a buffer, initiates the non-SDT procedure on at least one RACH resource that is not configured for SDT. In some example embodiments, the terminal device 110 transmits the request message by: transmitting, to the network device 120, the request message comprising the first identifier. In some example embodiments, the terminal device 110 further, based on determining that there is no uplink data in a buffer and RSRP of communication link is below an RSRP threshold, sets a cause in the request message to a first cause value indicating that the non-SDT procedure is for mobile terminated (MT) access. In some example embodiments, the terminal device 110 further, based on determining that there is uplink non-SDT data in a buffer, sets a cause in the request message to a second cause value indicating that the non-SDT procedure is for mobile originated (MO) access or MO data.

In some example embodiments, terminal device 110 further receives, from the network device 120, a paging message comprising the first identifier; and initiates the non-SDT procedure on at least one RACH resource that is not configured for SDT, and the terminal device 110 transmits the request message by: transmitting, to the network device 120, the request message comprising the first identifier.

In some example embodiments, the terminal device 110 further, prior to transmitting the request message, based on determining that there is uplink SDT data in a buffer and RSRP of communication link is above an RSRP threshold, initiates the SDT procedure on at least one RACH resource that is not configured for SDT, the SDT procedure being a mobile originated (MO)-SDT procedure, and the terminal device 110 transmits the request message by: transmitting, to the network device 120, the request message comprising the second identifier.

In some example embodiments, the RSRP threshold is different for MT-SDT than for MO-SDT.

In some example embodiments, the first and second identifiers are full inactive radio network temporary identifiers (I-RNTIs) or short I-RNTIs for an SDT procedure.

In some example embodiments, the message is a release message or a reconfiguration message.

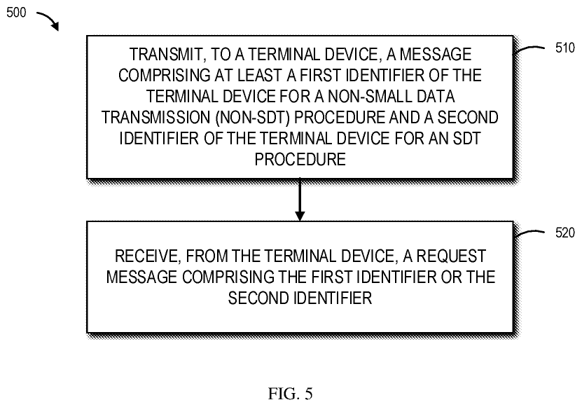

FIG. 5 illustrates a flowchart 500 of a method implemented at a network device 120 according to some embodiments of the present disclosure. For the purpose of discussion, the method 500 will be described from the perspective of the network device 120 with reference to FIG. 1.

At block 510, the network device 120 transmits, to a terminal device 110, a message comprising at least a first identifier of the terminal device 110 for a non-small data transmission (non-SDT) procedure and a second identifier of the terminal device 110 for an SDT procedure. At block 520, the network device 120 receives, from the terminal device 110, a request message comprising the first identifier or the second identifier.

In some example embodiments, the network device 120 further, prior to receiving the request message, transmits, to the terminal device 110, a paging message comprising the second identifier.

In some example embodiments, the network device 120 further, after transmitting the paging message comprising the second identifier, determines that the SDT procedure is initiated on at least one random access channel, RACH, resource that is not configured for SDT.

In some example embodiments, the network device 120 further, after transmitting the paging message comprising the second identifier, based on determining that the non-SDT procedure is initiated on at least one RACH resource that is not configured for SDT and the received request message comprises the first identifier, determines that reference signal received power (RSRP) of communication link at the terminal device 110 is below an RSRP threshold or there is uplink non-SDT data at the terminal device 110 to be transmitted; and configures the terminal device 110 to enter a connected state. In some example embodiments, the network device 120 determines that there is uplink non-SDT data at the terminal device 110 to be transmitted by: based on determining that a cause in the request message is set to a second cause value indicating that the non-SDT procedure is for mobile originated (MO) access, determining that there is uplink non-SDT data at the terminal device 110 to be transmitted. In some example embodiments, the RSRP threshold is different for MT-SDT than for MO-SDT.

In some example embodiments, the network device 120 further, after transmitting the paging message comprising the second identifier, determines that the non-SDT procedure is initiated on at least one RACH resource that is not configured for SDT and the received request message comprises the first identifier; determines that a cause in the request message is set to a first cause value indicating the non-SDT procedure is for mobile terminated (MT) access; and transmits, to the terminal device 110, SDT data without configuring the terminal device 110 to enter a connected state.

In some example embodiments, the network device 120 further, after transmitting the paging message comprising the second identifier, based on determining that the SDT procedure is initiated on at least one RACH resource that is not configured for SDT and the received request message comprises the second identifier, determines that there is no uplink SDT data at the terminal device 110 to be transmitted; and transmit, to the terminal device 110, SDT data without configuring the terminal device 110 to a connected state.

In some example embodiments, the network device 120 further, after transmitting the paging message comprising the second identifier, based on determining that the SDT procedure is initiated on at least one RACH resource configured for SDT and the received request message comprises the second identifier, determines that there is uplink SDT data at the terminal device 110 to be transmitted and the terminal device 110 has received the paging message comprising the second identifier.

In some example embodiments, the network device 120 further, prior to receiving the request message, transmits, to the terminal device 110, a paging message comprising the first identifier, and after transmitting the paging message comprising the first identifier, determines that the non-SDT procedure is initiated on at least one RACH resource that is not configured for SDT.

In some example embodiments, the network device 120 further, prior to receiving the request message comprising the second identifier, determines that the SDT procedure is initiated on at least one RACH resource that is not configured for SDT, the SDT procedure being a mobile originated (MO)-SDT procedure.

In some example embodiments, the first and second identifiers are full inactive radio network temporary identifiers (I-RNTIs) or short I-RNTIs for an SDT procedure.

In some example embodiments, the message is a release message or a reconfiguration message.

In some example embodiments, an apparatus capable of performing the method 400 (for example, the terminal device 110) may comprise means for performing the respective steps of the method 400. The means may be implemented in any suitable form. For example, the means may be implemented in a circuitry or software module.

In some example embodiments, the apparatus comprises means for receiving, from a network device, a message comprising at least a first identifier of the terminal device for a non-small data transmission (non-SDT) procedure and a second identifier of the terminal device for an SDT procedure; and means for transmitting, to the network device, a request message comprising the first identifier or the second identifier.

In some example embodiments, the means for transmitting the request message comprises: means for, based on receiving, from the network device, a paging message comprising the second identifier, transmitting, to the network device, the request message comprising the second identifier. In some example embodiments, the apparatus further comprises means for, prior to transmitting the request message comprising the second identifier, initiating the SDT procedure on at least one random access channel, RACH, resource that is not configured for SDT. In some example embodiments, the means for initiating the SDT procedure comprises means for, based on determining that there is no uplink SDT data in a buffer, initiating the SDT procedure on the at least one RACH resource that is not configured for SDT. In some example embodiments, the apparatus further comprises means for, prior to transmitting the request message comprising the second identifier, based on determining that there is uplink SDT data in a buffer, initiating the SDT procedure on at least one RACH resource configured for SDT. In some example embodiments, the means for initiating the SDT procedure comprises: means for further based on reference signal received power (RSRP) of communication link is above an RSRP threshold, initiating the SDT procedure. In some example embodiments, the means for initiating the SDT procedure comprises: means for further based on RSRP of communication link is below an RSRP threshold, initiating the SDT procedure.

In some example embodiments, the apparatus further comprises means for receiving, from the network device, a paging message comprising the second identifier; and means for, prior to transmitting the request message, based on determining that there is no uplink SDT data in a buffer and RSRP of communication link is below an RSRP threshold or there is uplink non-SDT data in a buffer, initiating the non-SDT procedure on at least one RACH resource that is not configured for SDT. In some example embodiments, the means for transmitting the request message comprises means for transmitting, to the network device, the request message comprising the first identifier. In some example embodiments, the apparatus further comprises means for, based on determining that there is no uplink data in a buffer and RSRP of communication link is below an RSRP threshold, set a cause in the request message to a first cause value indicating that the non-SDT procedure is for mobile terminated (MT) access. In some example embodiments, the apparatus further comprises means for, based on determining that there is uplink non-SDT data in a buffer, setting a cause in the request message to a second cause value indicating that the non-SDT procedure is for mobile originated (MO) access.

In some example embodiments, the apparatus further comprises means for receiving, from the network device, a paging message comprising the first identifier; and means for initiating the non-SDT procedure on at least one RACH resource that is not configured for SDT, and the means for transmitting the request message comprises means for transmitting, to the network device, the request message comprising the first identifier.

In some example embodiments, the apparatus further comprises means for, prior to transmitting the request message, based on determining that there is uplink SDT data in a buffer and RSRP of communication link is above an RSRP threshold, initiating the SDT procedure on at least one RACH resource that is not configured for SDT, the SDT procedure being a mobile originated (MO)-SDT procedure, and the means for transmitting the request message comprises means for transmitting, to the network device, the request message comprising the second identifier.

In some example embodiments, the RSRP threshold is different for MT-SDT than for MO-SDT.

In some example embodiments, the first and second identifiers are full inactive radio network temporary identifiers (I-RNTIs) or short I-RNTIs for an SDT procedure.

In some example embodiments, the message is a release message or a reconfiguration message.

In some example embodiments, the apparatus further comprises means for performing other steps in some embodiments of the method 400. In some embodiments, the means comprises at least one processor and at least one memory including computer program code. The at least one memory and computer program code are configured to, with the at least one processor, cause the performance of the apparatus.

In some example embodiments, an apparatus capable of performing the method 500 (for example, the network device 120) may comprise means for performing the respective steps of the method 500. The means may be implemented in any suitable form. For example, the means may be implemented in a circuitry or software module.

In some example embodiments, the apparatus comprises means for transmitting, to a terminal device, a message comprising at least a first identifier of the terminal device for a non-small data transmission (non-SDT) procedure and a second identifier of the terminal device for an SDT procedure; and means for receiving, from the terminal device, a request message comprising the first identifier or the second identifier.

In some example embodiments, the apparatus further comprises means for, prior to receiving the request message, transmitting, to the terminal device, a paging message comprising the second identifier.

In some example embodiments, the apparatus further comprises means for, after transmitting the paging message comprising the second identifier, determine that the SDT procedure is initiated on at least one random access channel, RACH, resource that is not configured for SDT.

In some example embodiments, the apparatus further comprises means for, after transmitting the paging message comprising the second identifier, based on determining that the non-SDT procedure is initiated on at least one RACH resource that is not configured for SDT and the received request message comprises the first identifier, determine that reference signal received power (RSRP) of communication link at the terminal device is below an RSRP threshold or there is uplink non-SDT data at the terminal device to be transmitted; and means for configuring the terminal device to enter a connected state. In some example embodiments, the means for determining that there is uplink non-SDT data at the terminal device to be transmitted comprises means for, based on determining that a cause in the request message is set to a second cause value indicating that the non-SDT procedure is for mobile originated (MO) access, determining that there is uplink non-SDT data at the terminal device to be transmitted. In some example embodiments, the RSRP threshold is different for MT-SDT than for MO-SDT.

In some example embodiments, the apparatus further comprises means for, after transmitting the paging message comprising the second identifier, determine that the non-SDT procedure is initiated on at least one RACH resource that is not configured for SDT and the received request message comprises the first identifier; means for determining that a cause in the request message is set to a first cause value indicating the non-SDT procedure is for mobile terminated (MT) access; and means for transmitting, to the terminal device, SDT data without configuring the terminal device to enter a connected state.

In some example embodiments, the apparatus further comprises means for, after transmitting the paging message comprising the second identifier, based on determining that the SDT procedure is initiated on at least one RACH resource that is not configured for SDT and the received request message comprises the second identifier, determining that there is no uplink SDT data at the terminal device to be transmitted; and means for transmitting, to the terminal device, SDT data without configuring the terminal device to a connected state.

In some example embodiments, the apparatus further comprises means for, after transmitting the paging message comprising the second identifier, based on determining that the SDT procedure is initiated on at least one RACH resource configured for SDT and the received request message comprises the second identifier, determining that there is uplink SDT data at the terminal device to be transmitted and the terminal device has received the paging message comprising the second identifier.

In some example embodiments, the apparatus further comprises means for, prior to receiving the request message, transmitting, to the terminal device, a paging message comprising the first identifier, and means for, after transmitting the paging message comprising the first identifier, determining that the non-SDT procedure is initiated on at least one RACH resource that is not configured for SDT.

In some example embodiments, the apparatus further comprises means for, prior to receiving the request message comprising the second identifier, determining that the SDT procedure is initiated on at least one RACH resource that is not configured for SDT, the SDT procedure being a mobile originated (MO)-SDT procedure.

In some example embodiments, the first and second identifiers are full inactive radio network temporary identifiers (I-RNTIs) or short I-RNTIs for an SDT procedure.

In some example embodiments, the message is a release message or a reconfiguration message.

In some example embodiments, the apparatus further comprises means for performing other steps in some embodiments of the method 500. In some embodiments, the means comprises at least one processor and at least one memory including computer program code. The at least one memory and computer program code are configured to, with the at least one processor, cause the performance of the apparatus.

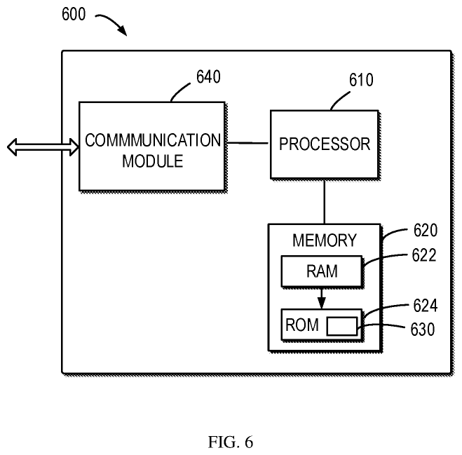

FIG. 6 illustrates a simplified block diagram of a device 600 that is suitable for implementing some example embodiments of the present disclosure. The device 600 may be provided to implement the communication device, for example, the terminal device 110, or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like.

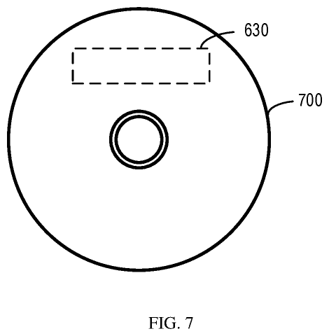

FIG. 7 illustrates a block diagram of an example of a computer readable medium 700 in accordance with some example embodiments of the present disclosure. The computer readable medium 700 has the program 630 stored thereon. It is noted that although the computer readable medium 700 is depicted in form of CD or DVD in FIG. 7, the computer readable medium 700 may be in any other form suitable for carry or hold the program 630.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 4-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A terminal device comprising:
at least one processor; and
at least one memory storing instructions that, when executed by the at least one processor, cause the terminal device at least to:
receive, from a network device, a message comprising a first identifier of the terminal device for a non-small data transmission (non-SDT) procedure and a second identifier of the terminal device for an SDT procedure, wherein the first identifier and the second identifier are full inactive radio network temporary identifiers (I-RNTIs);
determine that there is no uplink SDT data in a buffer; and
based on determining that there is no uplink SDT data in the buffer:
determining an RSRP of communication link is below an RSRP threshold;
based on determining the RSRP of communication link is below the RSRP threshold, set a cause in a request message to a first cause value indicating that the non-SDT procedure is for mobile terminated (MT) access, wherein the RSRP threshold is different for MT-SDT than for mobile originated (MO)-SDT;
prior to transmitting the request message comprising the second identifier, initiate the SDT procedure on at least one random access channel (RACH) resource that is not configured for SDT; and
based on initiating the SDT procedure, transmit, to the network device, a request message comprising the second identifier.

36. The terminal device of claim 35, wherein the message is a reconfiguration message.

37. The terminal device of claim 35, wherein the message is a release message.

38. The terminal device of claim 37, wherein upon receipt of the message, the instructions, when executed by the processor, further cause the terminal device to enter into an inactive state and store the I-RNTIs.

39. The terminal device of claim 38, wherein the instructions, when executed by the processor, further cause the terminal device to transmit SDT data in downlink and transmit subsequent uplink SDT data.

40. The terminal device of claim 39, wherein the instructions, when executed by the processor, further cause the terminal device to, receive, from the network device, SDT data without the terminal device being configured to enter a connected state.

41. The terminal device of claim 40, wherein the SDT procedure is a MO-SDT procedure.

42. A system comprising:
a terminal device comprising:
at least one processor; and
at least one memory storing instructions that, when executed by the at least one processor, cause the terminal device at least to:
receive, from a network device, a message comprising a first identifier of the terminal device for a non-small data transmission (non-SDT) procedure and a second identifier of the terminal device for an SDT procedure, wherein the first identifier and the second identifier are full inactive radio network temporary identifiers (I-RNTIs);
determine that there is no uplink SDT data in a buffer; and
based on determining that there is no uplink SDT data in the buffer:
determining an RSRP of communication link is below an RSRP threshold;
based on determining the RSRP of communication link is below the RSRP threshold, set a cause in a request message to a first cause value indicating that the non-SDT procedure is for mobile terminated (MT) access, wherein the RSRP threshold is different for MT-SDT than for mobile originated (MO)-SDT;
prior to transmitting the request message comprising the second identifier, initiate the SDT procedure on at least one random access channel (RACH) resource that is not configured for SDT; and
based on initiating the SDT procedure, transmit, to the network device, a request message comprising the second identifier.

43. The system of claim 42, wherein the message is a reconfiguration message.

44. The system of claim 42, wherein the message is a release message.

45. The system of claim 44, wherein upon receipt of the message, the instructions, when executed by the processor, further cause the terminal device to enter into an inactive state and store the I-RNTIs.

46. The system of claim 45, wherein the instructions, when executed by the processor, further cause the terminal device to transmit SDT data in downlink and transmit subsequent uplink SDT data.

47. The system of claim 46, wherein the instructions, when executed by the processor, further cause the terminal device to, receive, from the network device, SDT data without the terminal device being configured to enter a connected state.

48. The system of claim 47, wherein the SDT procedure is a MO-SDT procedure.

49. A method comprising:
receiving, by a terminal device from a network device, a message comprising a first identifier of the terminal device for a non-small data transmission (non-SDT) procedure and a second identifier of the terminal device for an SDT procedure, wherein the first identifier and the second identifier are full inactive radio network temporary identifiers (I-RNTIs);
determining that there is no uplink SDT data in a buffer; and
based on determining that there is no uplink SDT data in the buffer:
determining an RSRP of communication link is below an RSRP threshold;
based on determining the RSRP of communication link is below the RSRP threshold, set a cause in a request message to a first cause value indicating that the non-SDT procedure is for mobile terminated (MT) access, wherein the RSRP threshold is different for MT-SDT than for mobile originated (MO)-SDT;
prior to transmitting the request message comprising the second identifier, initiate the SDT procedure on at least one random access channel (RACH) resource that is not configured for SDT; and
based on initiating the SDT procedure, transmit, to the network device, a request message comprising the second identifier.

50. The method of claim 49, wherein the message is a release message.

51. The method of claim 50, wherein upon receipt of the message, the instructions, when executed by the processor, further cause the terminal device to enter into an inactive state and store the I-RNTIs.

52. The method of claim 51, wherein the instructions, when executed by the processor, further cause the terminal device to transmit SDT data in downlink and transmit subsequent uplink SDT data.

53. The method of claim 52, wherein the instructions, when executed by the processor, further cause the terminal device to, receive, from the network device, SDT data without the terminal device being configured to enter a connected state.

54. The method of claim 53, wherein the SDT procedure is a MO-SDT procedure.
